(19) United States
(12) Patent Application Publication
(10) Pub. No.: US 2016/0210477 A1
(43) Pub. Date: Jul. 21, 2016

(54) SYSTEM AND METHOD OF RAPID DEPLOYMENT OF TRUSTED EXECUTION ENVIRONMENT APPLICATION

(71) Applicant: GOTRUST TECHNOLOGY INC., TAICHUNG CITY (TW)

(72) Inventors: TIEN-CHI LEE, Taichung City (TW); JENG LUNG LEE, Taichung City (TW); YI-HSIUNG HUANG, Taichung City (TW)

(21) Appl. No.: 14/933,747

(22) Filed: Nov. 5, 2015

(30) Foreign Application Priority Data
Jan. 20, 2015 (TW) 104101861

(51) Int. Cl. G06F 21/62; H04L 29/06

(52) U.S. Cl. CPC G06F 21/6263; H04L 63/0428

(57) ABSTRACT

A system of rapid deployment of TEE application includes an REE application, a contact platform, and a TEE application. The REE application is installed with at least one APP and at least one intermediate service module. The intermediate service module provides a management service for the at least one APP. The at least one APP can transmit confidential data via the intermediate service module. The contact platform can receive the confidential data from the intermediate service module and further transmit the confidential datum. The TEE application is installed with a secure storage and calculation application module for receiving the confidential data from the contact platform and providing the confidential data with a trusted environment in such a way that the confidential data can be saved, processed, and protected in the secure storage and calculation application module.

### CROSS-REFERENCE TO RELATED APPLICATIONS

This application claims priority to Taiwan Patent Application No. 104101861 filed on Jan. 20, 2015, the contents of which are incorporated herein by reference in their entirety.

### BACKGROUND OF THE INVENTION

1. Field of the Invention

The present invention relates generally to electronic communication and more particularly, to a system of rapid deployment of trusted execution environment (TEE) application and a method of the same.

2. Description of the Related Art

As users of smart phones become more and more, protection against malwares and viruses becomes increasingly imperative. In the smart phones, some application programs (APPs) need higher security, e.g. APPs of banking management or receiving/sending confidential e-mails, because tragic outcomes will happen after these APPs are compromised. For this reason, these APPs need more security protection measures in addition to what are provided by themselves.

Trusted Execution Environment (TEE) is a new security technology and available in a secure area of every smart phone, every tablet computer, or every randomly mobile device. TEE provides a secure execution environment, guaranteeing that various sensitive and confidential data can be saved, processed, and protected in a trusted environment. TEE coexist with Rich Operation System (OS), namely Android, Symbian, or Windows Phone, and provides Rich OS with secure services. Moreover, TEE has its own execution space to have higher security level than that of Rich OS and TEE can satisfy most of APPs with higher security and confidentiality.

Referring to FIG. 1, a mobile device 100 includes a Rich Execution Environment (REE) application 1, a TEE application 2, and a contact platform 3. The REE application 1 and the TEE application 2 are coexistent with each other. The REE application 1 is the OS of the mobile device 100 itself and includes a client application module 11, a TEE function application program interface (API) 12, a TEE client API 13, and a Rich OS element 14. The client application module 11 further includes various APPs installed by a client user, such as a banking management APP 111, a virtual private network (VPN) APP 112, a secure short message service (SMS) APP 113, and a secure voice APP 114. These APPs can be added or deleted according to the client's need. However, data received and transmitted by the banking management APP 111, the VPN APP 112, the secure SMS APP 113, and the secure voice APP 114 are very sensitive to need to keep secret and the REE application 1 is of lower level of security and confidentiality itself to have the risk of data theft. For this reason, the TEE application 2 is needed to provide a secure execution environment, securing that various sensitive and confidential data can be saved, processed, and protected in a trusted environment.

The TEE application 2 includes a trusted application module 21, a TEE API 22, and a trusted OS element 23. The trusted application module 21 further includes a variety of trusted APPs corresponding to the client application module 11, such as a trusted banking management APP 211, a trusted VPN APP 212, a trusted secure SMS APP 213, and a trusted secure voice APP 214. Once the trusted APPs of the TEE application 2 are deployed completely, the REE application 1 can transmit the data in need of confidentiality to the corresponding trusted APPs 211-214 via the contact platform 3, securing that all kinds of sensitive and confidential data can be saved, processed, and protected in a trusted environment.

However, the trusted APPs 211-214 of the trusted application module 21 of the TEE application 2 correspond to the APPS 111-114 of the client application module 11 of the REE application 1, respectively, so if the client application module 11 needs to add a new APP into the trusted application module 21 under such system architecture, it will be necessary to feel at home in the general development of the REF application 1 and understand the manner of developing the TEE application 2 and even the manner of calling of cryptographic computation at the base layer, thus leading to a higher barrier to entry. Besides, it will take much more time if one said REE application 1 works with one said TEE application 2 for development. Therefore, it is not a good method of rapid deployment of system software.

In terms of TEE applications, the aforesaid prior art needs further improvement by structuring a general secure storage and calculation application at the conventional TEE application terminal and providing a common standard interface, e.g. public key cryptography standards 11 (PKCS#11) serving as a middleware for development of secure software at the REE application to simply allow various client APPs in the REE application to rapidly deploy their existing systems to the TEE application architecture.

### SUMMARY OF THE INVENTION

The primary objective of the present invention is to provide a system of rapid deployment of TEE application. The system includes an REF application installed therein with at least one APP and at least one intermediate service module, the intermediate service module providing a management service for the at least one APP, the at least one APP adapted for transmitting confidential data via the intermediate service module; a contact platform adapted for receiving the confidential data from the intermediate service module and transmitting the confidential datum; and a TEE application installed therein with a secure storage and calculation application module, the secure storage and calculation application module adapted for receiving the confidential data from the contact platform and providing the confidential data with a trusted environment in such a way that the confidential data can be saved, processed, and protected in the secure storage and calculation application module.

Preferably, the intermediate service module can apply key management and protection of personal private data to the at least one APP.

Preferably, the at least one APP includes a new APP added by a user into the REE application.

Preferably, the intermediate service module conforms to PKCS#11.

Preferably, the system can be installed in a smart phone, a tablet computer, or a randomly mobile device.

In a preferred embodiment, the system includes an REE application installed therein with at least one APP and at least one intermediate service module, the at least one intermediate service module adapted for providing a management service for the at least one APP and the at least one APP adapted for transmitting confidential data via the intermediate service module; a contact platform adapted for receiving the confidential data from the intermediate service module and transmitting the confidential data a TEE application installed therein with a secure storage and calculation application module, the secure storage and calculation application module adapted for receiving the confidential data from the contact platform and further transmitting the confidential data; and a security module adapted for receiving the confidential data and providing the confidential data with a trusted environment in such a way that the confidential datum can be saved, processed, and protected in the secure storage and calculation application module.

Preferably, the intermediate service module can apply key management and protection of personal private data to the at least one APP.

Preferably, the at least one APP includes a new APP added by a user into the REE application.

Preferably, the security module is a microSD card, a subscriber identity module (SIM) card, an embedded secure element (SE), a wired external device, or a wireless external device.

Preferably, the intermediate service module conforms to PKCS#11.

Preferably, the system can be installed in a smart phone, a tablet computer, or a mobile device.

The secondary objective of the present invention is to provide a method of rapid deployment of TEE application. The method includes the steps of transmitting an intermediate instruction to an intermediate service module from at least one APP of an REE application; converting the intermediate instruction, by the intermediate service module, into an instruction set that can be processed by a secure storage and calculation application module; transmitting the instruction set to the secure storage and calculation application module via a contact platform; receiving the instruction set and keeping processing the instruction set until the instruction set is completely received by the secure storage and calculation application module; returning a responsive instruction to the intermediate service module via the contact platform from the secure storage and calculation application module; preparing to respond according to the responsive instruction by the intermediate service module; and transmitting the responsive instruction to the at least one APP from the intermediate service module.

Preferably, the at least one APP includes a new APP added by a user into the REE application.

In a preferred embodiment, the method includes the steps of transmitting an intermediate instruction to an intermediate service module from at least one APP of an REE application; converting the intermediate instruction, by the intemediate service module, into an instruction set that can be processed by a secure storage and calculation application module; transmitting the instruction set to the secure storage and calculation application module via a contact platform; transmitting the instruction set to a secure module via the contact platform from the secure storage and calculation application; receiving the instruction set and returning a responsive instruction to the secure storage and calculation application module from the secure module via the contact platform; receiving the instruction set from the secure storage and calculation application module and transmitting the instruction set to the secure module via the contact platform; transmitting the responsive instruction to the intermediate service module from the secure storage and calculation application module via the contact platform; preparing to respond according to the responsive instruction by the intermediate service module; and transmitting the responsive instruction to the at least one APP from the intermediate service module.

Preferably, the at least one APP includes a new APP added by a user into the REE application.

Preferably, the security module is a microSD card, a SIM card, an embedded SE, a wired external device, or a wireless external device.

### BRIEF DESCRIPTION OF THE DRAWINGS

FIG. 1 is a block diagram, illustrating a conventional application based on TEE.

FIG. 2 is a block diagram of a system of rapid deployment of TEE application in accordance with the present invention.

FIG. 3 is a block diagram view of the system of rapid deployment of TEE application in accordance with a first preferred embodiment of the present invention.

FIG. 4 is a flow chart of a method of rapid deployment of TEE application in accordance with the first preferred embodiment of the present invention.

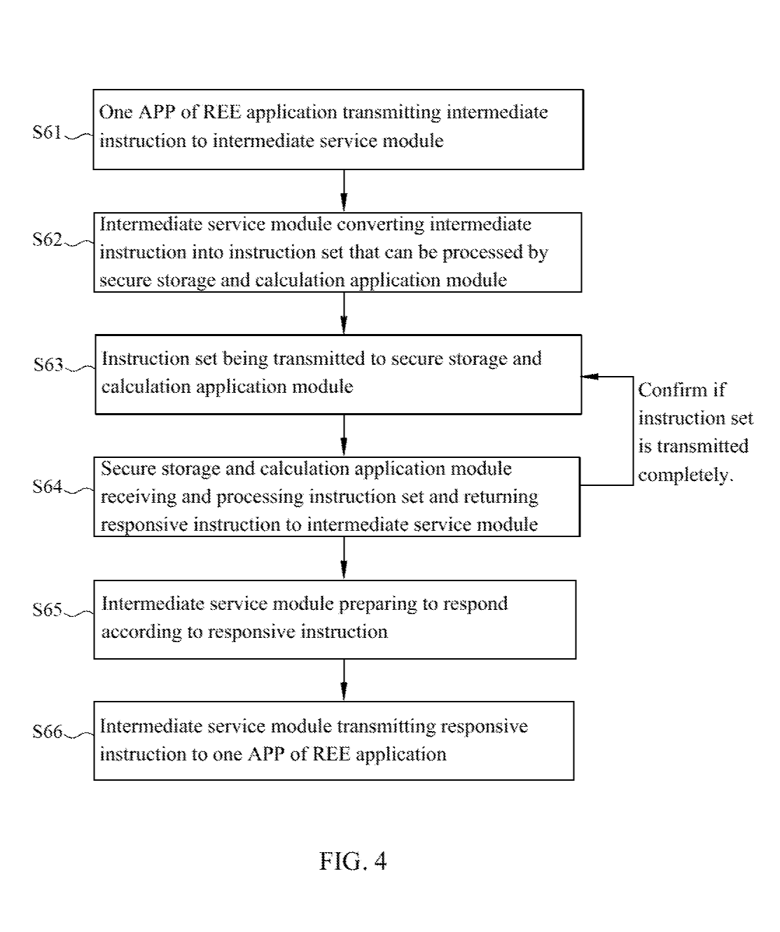

FIG. 5 is a block diagram view of a system of rapid deployment of TEE application in accordance with a second preferred embodiment of the present invention.

FIG. 6 is a flow chart of a method of rapid deployment of TEE application in accordance with the second preferred embodiment of the present invention.

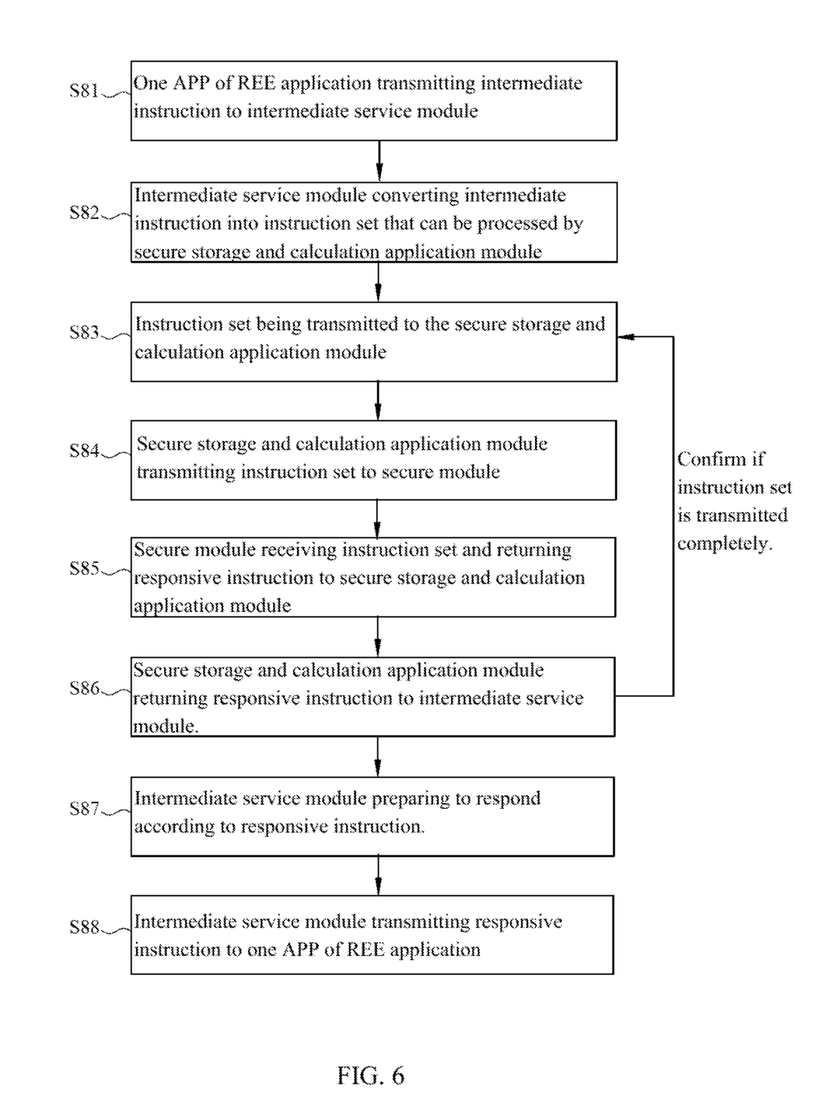

FIG. 7 illustrates comparison between the flow chart of the present invention and that of the prior art.

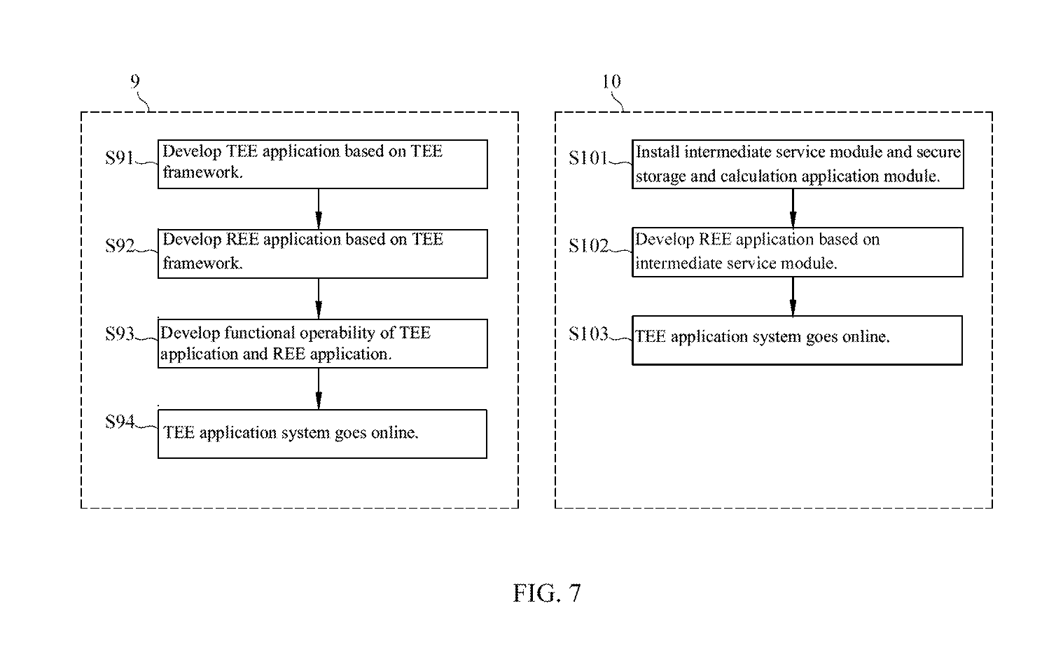

### DETAILED DESCRIPTION OF PREFERRED EMBODIMENTS

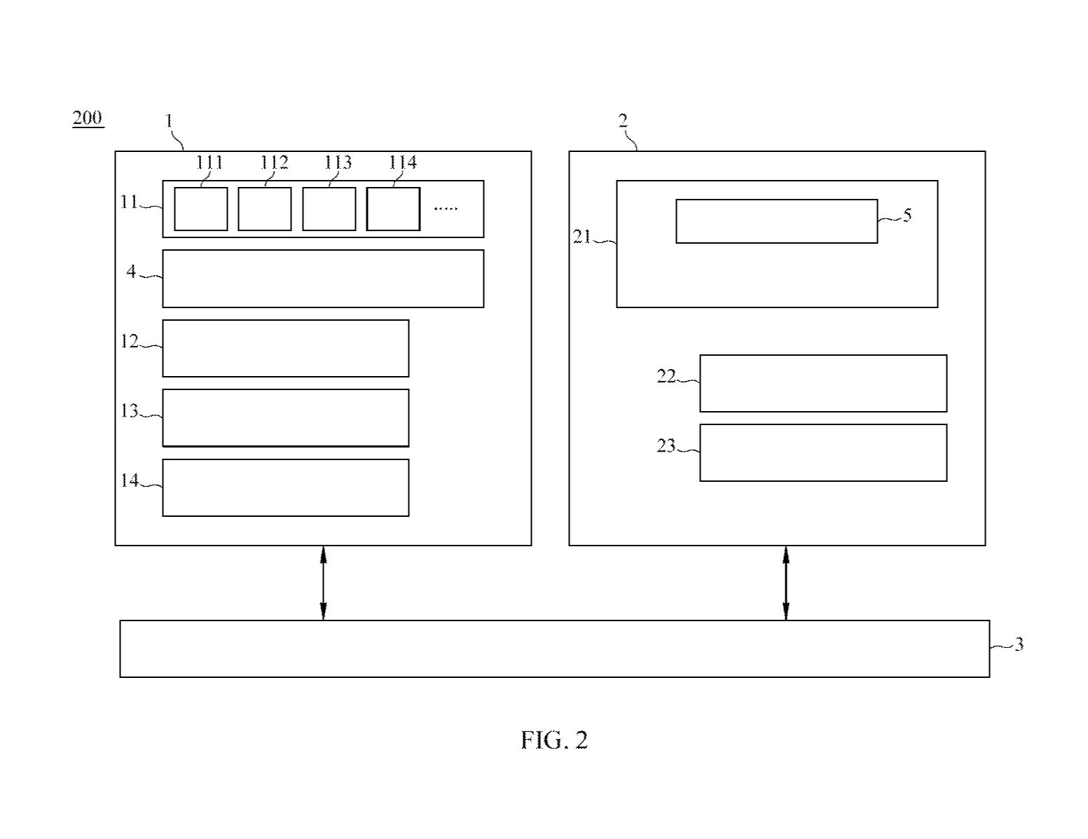

Referring to FIG. 2, a system 200 of rapid deployment of TEE application in accordance with a first preferred embodiment of the present invention is formed of an REE application 1, a TEE application 2, and a contact platform 3. The REE application and the TEE application 2 are coexistent in the system 200. The REE application 1 is an OS for hardware and includes a client application module 11, an intermediate service module 4, a TEE function API 12, a TEE client API 13, and a Rich OS element 14. The client application module 11 further includes a variety of APPs installed by a client user in private, e.g. a banking management APP 111, a virtual private network (VPN) APP 112, a secure short message service (SMS) APP 113, and a secure voice APP 114 where these APPs can be added or removed subject to the client user's discretion. The intermediate service module 14 can provide a management service for the APPs 111-114. The APP s 111-114 can proceed with transmission of confidential data, key management, and protection of personal private information via the intermediate service module 4. When the client user adds a new APP 115 into the client application module 11, the new APP 115 can also do management via the intermediate service module 4. To accelerate the deployment of the TEE application 2, the intermediate service module 4 can serve as middleware by means of PCKS#11 to enable the APPs 111-114 to simply deploy their existing systems to the TEE application 2.

The TEE application 2 includes a trusted application module 21, a TEE API 22, and a trusted OS 23. The trusted API 21 further includes a secure storage and calculation application module 5. The secure storage and calculation application module 5 can provide a variety of management of personal private information, key management, and cryptographic service for the APPs 111-114. In a preferred embodiment, once the secure storage and calculation application module 5 is installed in the trusted application module 21, the REE application 1 can use the intermediate service module 4 to transmit various data needing to keep secret to the secure storage and calculation application module 5 via the contact platform 3, thus assuring storage, processing, and protection of various sensitive and confidential data under the trusted environment. In another preferred embodiment, the REE application 1 can use the intermediate service module 4 to transmit various data needing to keep secret to the secure storage and calculation application module 5 via the contact platform 3, and then the secure storage and calculation application module 5 can further transmit the data needing, to keep secret to a secure module (not shown) via the contact platform 3, thus assuring storage, processing, and protection of various sensitive and confidential data under the trusted environment.

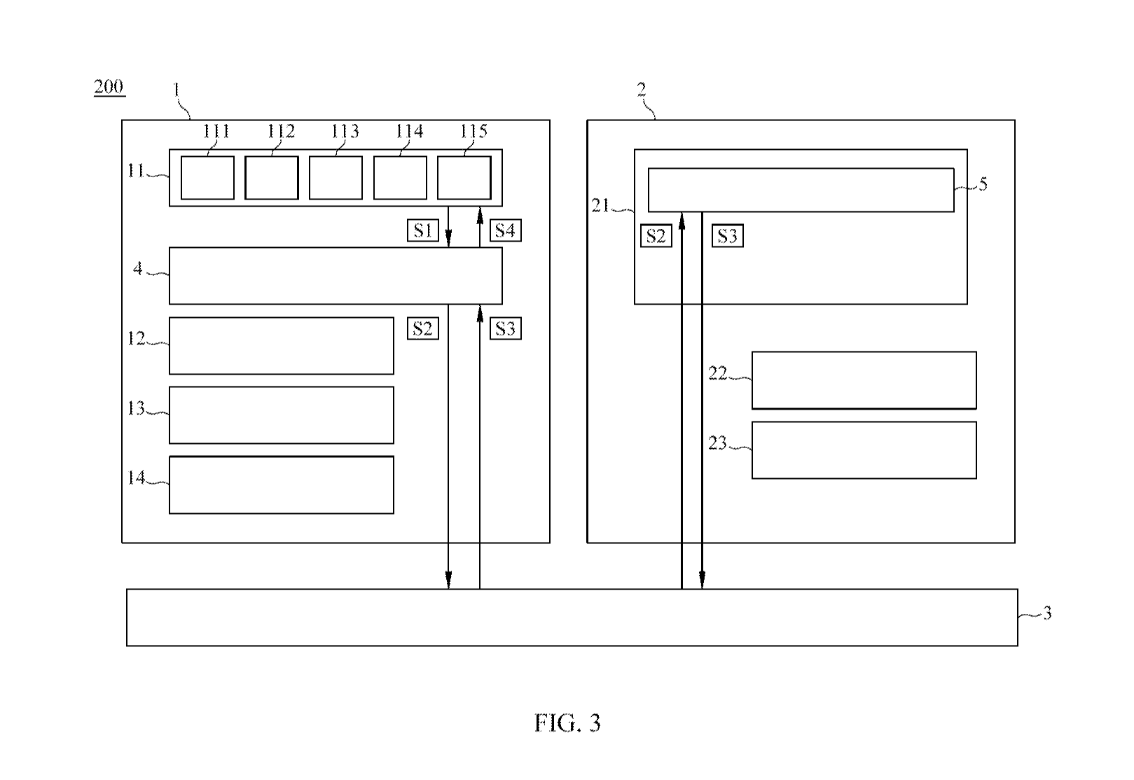

Referring to FIGS. 3 & 4, a method of rapid deployment of TEE application in accordance with a first preferred embodiment of the present invention includes steps S61-66. In the step S61, the APP 115 transmits an intermediate instruction S1 the intermediate service module 4. In other embodiments, what transmits the intermediate instruction Si to the intermediate service module 4 can be one of the APPs 111-114. In the step S62, the intermediate service module 4 converts the intermediate instruction S1 into an instruction set S2 which can be processed by the secure storage and calculation application module 5. In the step S63, the instruction set S2 is transmitted to the secure storage and calculation application module 5 via the contact platform 3. In the step S64, the secure storage and calculation application module 5 receives the instruction set S2 and keeps processing it until the instruction set S2 is completely received. After that, the secure storage and calculation application module 5 returns and transmits a responsive instruction S3 to the intermediate service module 4 via the contact platform 3. In the step S65, the intermediate service module 4 prepares to respond according to the responsive instruction S3. In the step S66, the intermediate service module 4 transmits a responsive instruction S4 to the APP 115.

In the first preferred embodiment of the present invention, the intermediate instruction S1 can be confidential data transmitted from one of the APPs 111-115. The intermediate service module 4 can convert the confidential data into what the secure storage and calculation application module 5 could process. The intermediate service module 4 can provide the APPs 111-115 with a management service. Each of the APPs 111-115 can carry out transmission of confidential data, key management, and protection of personal private data through the intermediate service module 4. Through the contact platform 3, the REE application 1 can use the intermediate service module 4 to transmit a variety of data needing to keep confidential to the secure storage and calculation application module 5, thus ensuring storage, processing, and protection of various sensitive and confidential data in the secure storage and calculation application module 5. In addition, the system 200 of rapid deployment of TEE application in accordance with the first preferred embodiment of the present invention can be installed in a smart phone, a tablet computer, or a randomly mobile device.

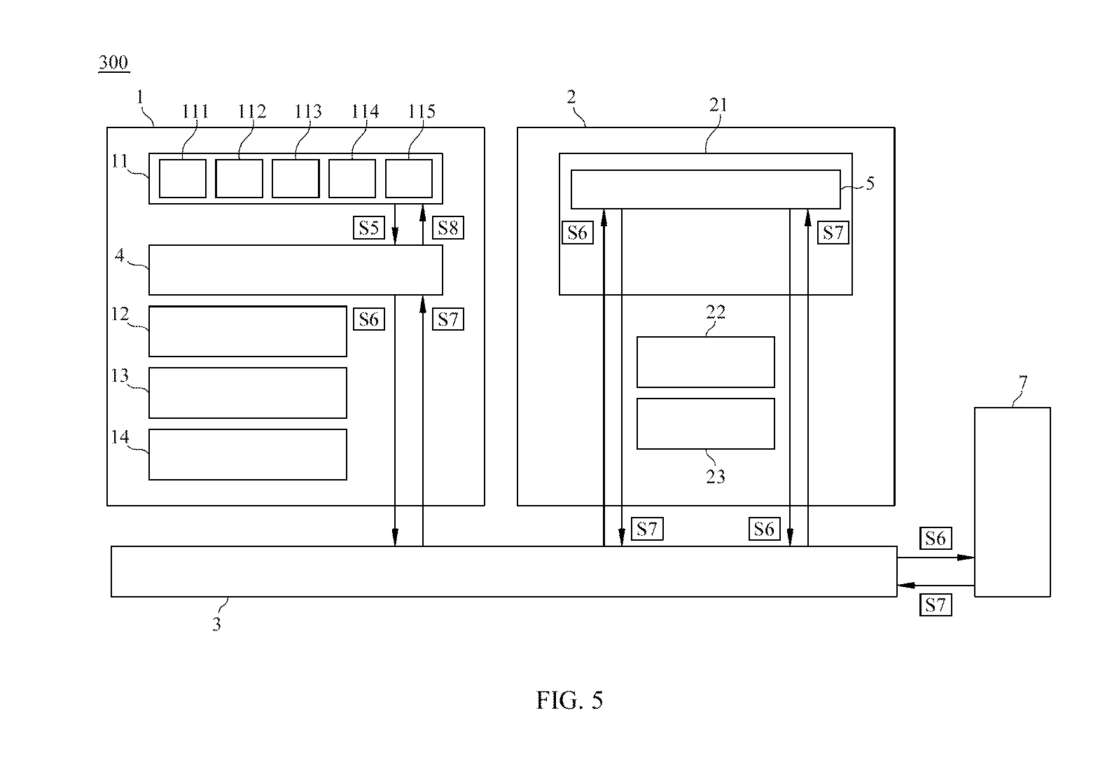

Referring to FIGS. 5 & 6, a system of rapid deployment of TEE application in accordance with a second preferred embodiment of the present invention is similar to that of the first preferred embodiment. The difference between the systems 200 and 300 lies in that the system 300 further includes a secure module 7, which can be a microSD card, a SIM card, an embedded SE, a wired external device, or a wireless external device. In the second preferred embodiment, the secure module 7 is a trusted environment ensuring storage, processing, and protection of various sensitive and confidential data therein.

A method of rapid deployment of TEE application in accordance with the second preferred embodiment of the present invention includes steps S81-88. In the step S81, the APP 115 can transmit an intermediate instruction S5 to the intermediate service module 4. In other embodiments, what transmits the intermediate instruction 55 to the intermediate service module 4 can be one of the APPs 111-114. In the step S82, the intermediate service module 4 converts the intermediate instruction S5 into an instruction set S6 which can be processed by the secure module 7. In the step S83, the instruction set S6 is transmitted to the secure storage and calculation application module 5 via the contact platform 3. In the step S84, the secure storage and calculation application module 5 transmits the instruction set S6 to the secure module 7 via the contact platform 3. In the step S85, the secure module 7 receives and processes the instruction set S6 and then returns a responsive instruction S7 to the secure storage and calculation application module 5. In the step S86, the secure storage and calculation application module 5 receives the instruction set S6 and keeps transmitting it to the secure module 7 via the contact platform 3 until the instruction set S6 is transmitted completely. After that, the secure storage and calculation application module 5 transmits the responsive instruction S7 returned from the secure module 7 and returns the responsive instruction S7 to the intermediate service module 4 via the contact platform 3. In the step S87, the intermediate service module 4 prepares to respond according to the responsive instruction S7. In the step S88, the intermediate service module 4 transmits a responsive instruction S8 to the APP 115.

In the second preferred embodiment of the present invention, the intermediate instruction S5 can confidential data transmitted by one of the APPs 111-115. The intermediate service module 4 can convert the confidential data into what the secure storage and calculation application module 5 can process. The intermediate service module 4 can provide a management service for the APPs 111-115. Each of the APPs 111-115 can carry out transmission of confidential data, key management, and protection of personal private data through the intermediate service module 4. The REE application 1 can use the intermediate service module 4 to transmit a variety of data needing to keep confidential to the secure storage and calculation application module 5 via the contact platform 3. After that, the secure storage and calculation application module 5 can transmit the data needing to keep confidential to the secure module 7 via the contact platform 3, thus ensuring storage, processing, and protection of various sensitive and confidential data in the secure module 7. In addition, the system 300 of rapid deployment of TEE application in accordance with the second preferred embodiment of the present invention can be installed in a smart phone, a tablet computer, or a randomly mobile device.

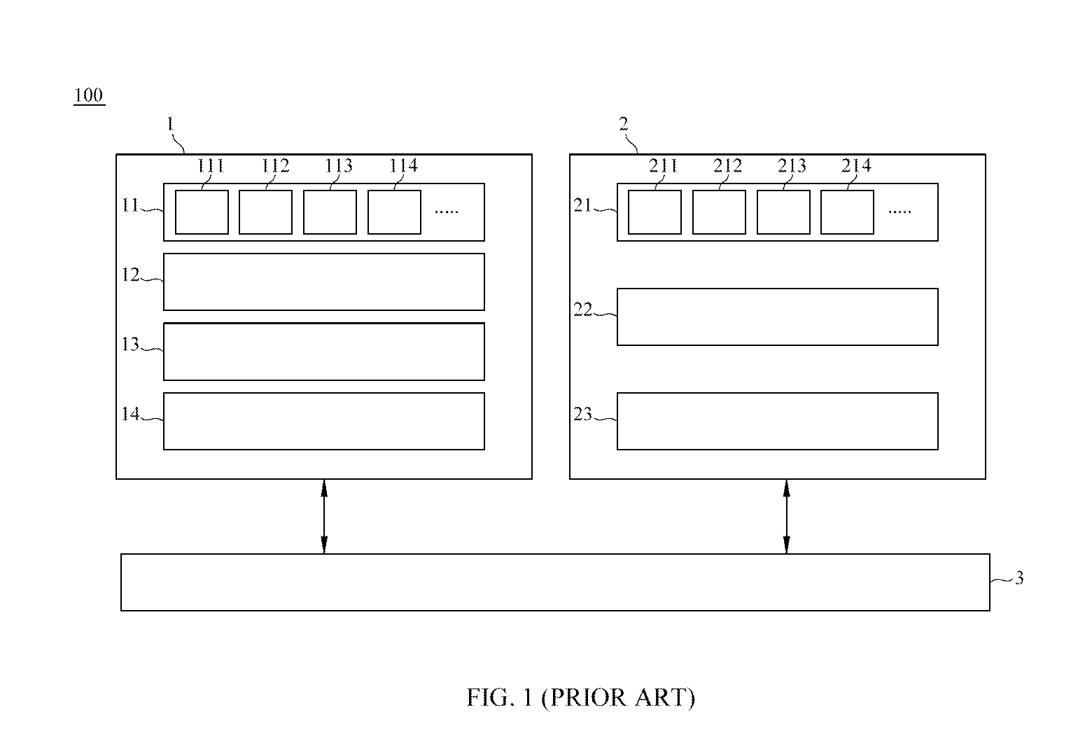

Referring to FIGS. 1, 2 & 7, a conventional process 9 of deployment of TEE application includes steps S91-94. In the step S91, a TEE application system needs to develop a TEE application 1 based on TEE framework. In the step S92, the TEE application system develops an REE application 2 based on TEE framework. In the step S93, the TEE application system develops functional operability of the TEE application 1 and the REE application 2. In the step S94, the TEE application system goes online. When the TEE application system develops functional operability of the TEE application 1 and the REE application 2, if a client user of the REE application 1 intends to add a new APP into the TEE application 2, the client user will not only need to be familiar with general development of the REE application 1 but need to understand how to develop the TEE application 2 and even the bottommost calling of cryptographic computation, thus leading to a higher barrier to entry. Besides, it will take much more time for development if the TEE application 1 works with the REE application 2 one on one. Therefore, the conventional process is anything but method of rapid deployment of TEE application. However, the method 10 of rapid deployment of TEE application of the present invention includes steps S101-103. In the step S101, the system 200 of rapid deployment of TEE application needs to install the intermediate service module 4 and the secure storage and calculation application module 5 beforehand. In the step S102, the system 200 develops the REE application 2 based on the intermediate service module 4. In the step S103, the system 200 can go online. Compared with the conventional process 9, the method 10 of the present invention installs the secure storage and calculation application module 5 into the TEE application 1 beforehand and then the REE application 2 is installed with the intermediate service module 4 such that the intermediate module 4 can serve as middleware to enable the APPS 111-114 to simply deploy their existing systems to the TEE application 1 soon, thus effectively shortening, time to market. In addition, the intermediate service module 4 of the present invention takes advantage of PKCS#11 and both of the intermediate service module 4 and the secure storage and calculation application module 5 conform to Rivest-Shamir-Adleman (RSA) cryptographic algorithm and international standards organization (ISO) 7816, so the barrier to entry into development of the TEE application 1 and the REE application 2 can be effectively lowered.

Although the present invention has been described with respect to specific preferred embodiments thereof, it is in no way limited to the specifics of the illustrated structures but changes and modifications may be made within the scope of the appended claims.

What is claimed is:

1. A system of rapid deployment of trusted execution environment (TEE) application, comprising:
a rich execution environment (REE) application installed with at least one application program (APP) and at least one intermediate service module, the intermediate service module providing the at least one APP with a management service, the at least one APP being adapted to transmit confidential data via the intermediate service module;
a contact platform adapted for receiving the confidential data from the intermediate service module and transmitting the confidential data; and
a TEE application installed with a secure storage and calculation application module, the secure storage and calculation application module being adapted to receive the confidential data from the contact platform and provide the confidential data with a trusted environment, whereby the confidential data is stored, processed, and protected in the secure storage and calculation application module.

2. The system as defined in claim 1, wherein the intermediate service module applies key management and protection of personal private data to the at least one APP.

3. The system as defined in claim 1, wherein the at least one APP comprises a new APP added by a user into the REE application.

4. The system as defined in claim 1, wherein the intermediate service module conforms to public key cryptography standards 11 (PKCS# 11).

5. The system as defined in claim 1, wherein the system is installed in a smart phone, a tablet computer, or a randomly mobile device.

6. A system of rapid deployment of TEE application, comprising:
an REE application installed with at least one APP and at least one intermediate service module, the intermediate service module providing the at least one APP with a management service, the at least one APP being adapted to transmit confidential data via the intermediate service module;
a contact platform adapted for receiving the confidential data from the intermediate service module and further transmitting the confidential data;
a TEE application installed with a secure storage and calculation application module, the secure storage and calculation application module being adapted to receive the confidential data from the contact platform and further transmit the confidential data; and
a secure module adapted for receiving the confidential data and further providing the confidential data with a trusted environment, whereby the confidential data is stored, processed, and protected in the secure storage and calculation application module.

7. The system as defined in claim 6, wherein the intermediate service module applies key management and protection of personal private data to the at least one APP.

8. The system as defined in claim 6, wherein the at least one APP comprises a new APP added by a user into the REE application.

9. The system s defined in claim 6, wherein the secure module is a microSD card, a subscriber identity module (SIM) card, an embedded secure element (SE), a wired external device, or a wireless external device.

10. The system as defined in claim 6, wherein the intermediate service module conforms to the PKCS#11.

11. The system as defined in claim 6, wherein the system is installed in a smart phone, a tablet computer, or a randomly mobile device.

12. A method of rapid deployment of TEE application, comprising steps of:
transmitting an intermediate instruction to an intermediate service module from an REE application;
converting the intermediate instruction by the intermediate service module into an instruction set which the secure storage and calculation module is able to process;
transmitting the instruction set to the secure storage and calculation module via a contact platform;
receiving the instruction set and then keeping processing the instruction set until the secure storage and calculation module completely receives the instruction set;
returning a responsive instruction to the intermediate service module via the contact platform from the secure storage and calculation module;
preparing to respond by the intermediate service module according to the responsive instruction; and
transmitting the responsive instruction to the at least one APP of the REE application from the intermediate service module.

13. The method as defined in claim 12, wherein the at least one APP comprises a new APP added by a user into the REE application.

14. A method of rapid deployment of TEE application, comprising steps of
transmitting an intermediate instruction to an intermediate service module from at least one APP of an REE application:
converting the intermediate instruction by the intermediate service module into an instruction set which the secure storage and calculation module is able to process;
transmitting the instruction set to the secure storage and calculation module via a contact platform;
transmitting the instruction set to a secure module from the secure storage and calculation module via the contact platform;
receiving the instruction set and returning a responsive instruction to the secure storage and calculation module by the secure module via the contact platform;
keeping receiving the instruction set by the secure storage and calculation module and then keeping transmitting the instruction set to the secure module from the secure storage and calculation module until the instruction set is completely transmitted;
transmitting the responsive instruction returned from the secure module to the intermediate service module from the secure storage and calculation module via the contact platform;
preparing to respond by the intermediate service module according to the responsive instruction transmitted from the secure module; and
transmitting the responsive instruction to the at least one APP of the REE application from the intermediate service module.

15. The method as defined in claim 14, wherein the at least one APP comprises a new APP added by a user into the REE application.

16. The method as defined in claim 14, wherein the secure module is a microSD card, a SIM card, an embedded SE, a wired external device, or a wireless external device.
